(19) United States
(12) Patent Application Publication
(10) Pub. No.: US 2009/0096770 A1
(43) Pub. Date: Apr. 16, 2009

(54) DETECTING DEFECTS IN DISPLAY PANEL PIXELS

(76) Inventor: Kazuyoshi Kawabe, Yokohama (JP)

Correspondence Address: J. Lanny Tucker;Patent Legal Staff, Eastman Kodak Company, 343 State Street, Rochester, NY, 14650-2201, US

(21) Appl. No.: 12/241,392

(22) Filed: Sep. 30, 2008

(30) Foreign Application Priority Data
Oct. 10, 2007 (JP) 2007-263905

(51) Int. Cl. G06F 3/038

(52) U.S. Cl. 345/204

(57) ABSTRACT

A method of detecting a defect in a display panel, includes providing a display panel comprising a plurality of pixels arranged in a matrix form, wherein each pixel comprises a static memory and emits light according to data stored in the static memory; writing data to the static memory of each pixel; reading the data stored in the static memory of each pixel; and comparing the data written and read for each pixel to produce a respective comparison result indicating presence of a defect.

### CROSS-REFERENCE TO RELATED APPLICATION

This application claims priority of Japanese Patent Application No. 2007-263905 filed Oct. 10, 2007 which is incorporated herein by reference in its entirety.

### FIELD OF THE INVENTION

The present invention relates to a display panel having pixels arranged in a matrix shape, and to detecting defects in such a display panel.

### BACKGROUND OF THE INVENTION

At the fabrication stage of an active matrix type display, rapid detection of defects is an effective way of improving yield. Cause analysis can be started at an early stage, and as well as being in place at an early stage in process correction, it is also useful in preventing a substrate that has defects progressing to subsequent stages, thus avoiding wasteful fabrication.

Japanese Patent Publication 2002-221547A discloses an example of introducing an array test in a manufacturing process for a liquid crystal panel. This document shows inspection means for electrically inspecting transistors arranged on a thin film transistor substrate (TFT substrate) used in the liquid crystal panel before the TFT substrate is glued to an opposing substrate. In this way, it is easy to detect defects on the TFT substrate.

Here, among the defects, there can be some that arise as a result of the gluing together of a TFT substrate with no defects and an opposing substrate with no defects. There is an increase in the causes of defects with the increase in number of transistors accompanying increase in size of the TFT substrate and increase in number of pixels. The probability of defects arising in a TFT with no defects in subsequent processing is therefore increased. For this reason, it is desirable for electrical inspection to be carried out not only for a TFT substrate but also at the final stages of panel fabrication.

### SUMMARY OF THE INVENTION

The present invention is directed to a method of detecting defects in a display panel having pixels arranged in a matrix form, wherein each pixel includes a static memory and emits light according to data stored in the static memory, data is written to the static memory of each pixel, followed by reading of data stored in the static memory, and whether or not there is a defective pixel is detected by comparing the written data with the read data.

It is also suitable to understand the positions of defective pixels as a map.

The present invention is also directed to a display panel having pixels arranged in a matrix form, wherein each pixel includes a static memory and emits light according to data stored in the static memory, externally supplied data being written to the static memory of each pixel, followed by reading of data stored in the static memory, and externally outputting the read data.

It is also appropriate to perform the writing of data to the static memory by sequentially supplying data on a data bus to data lines provided for each pixel row, and to perform reading of data from the static memory by sequentially reading out data on the data lines provided for each pixel row to the data bus.

It is also appropriate for a pixel region where pixels are arranged in a matrix form to be set large compared to a display region for a single screen It is also appropriate to be able to set the display region to an arbitrary position inside the pixel region.

It is also appropriate for the display region to be sequentially changed to a plurality of different positions every predetermined frame.

It is also appropriate to have a defect information memory for storing information about positions where defects have occurred, and set the position of the display region based on positions where defects have occurred stored in the defect information memory.

It is also appropriate for a plurality of the pixels to be collected together to form a unit pixel for dividing and displaying data for a single pixel portion.

It is also appropriate for a plurality of pixels forming the unit pixel to have respectively different display brightness.

It is also appropriate for a plurality of pixels forming the unit pixel to have respectively different surface areas.

It is also appropriate for a plurality of pixels forming the unit pixel to have the same surface area and drive currents of differing magnitudes.

It is also appropriate for writing of data to the static memory to be carried out by sequentially supplying data to a data line provided for each pixel row, for reading of the data from the static memory to be carried out by sequentially reading out data on the data line provided for each pixel row, and for a comparator for acquiring and storing data on a data line, then comparing stored data with data on the data line and storing a comparison result, and further outputting the comparison result to the data line, to be provided on each data line.

According to the present invention, pixel defects are detected by writing data to a static memory provided in a pixel and then reading the data. As a result, it is possible to effectively carry out defect detection at a stage subsequent to fabrication of each pixel of a display panel.

### BRIEF DESCRIPTION OF THE DRAWINGS

FIG. 1 shows the structure of a pixel circuit used in embodiments;

FIG. 2 shows a structural example for detecting defective pixels of a display panel of the embodiments;

FIG. 3 is a drawing showing positions of defective pixels;

FIG. 4 is a drawing showing a system for inspection;

FIG. 5 is a drawing showing a pixel region and a display region;

FIG. 6 is a drawing showing a structural example of a unit pixel;

FIG. 7 shows a structural example for detecting defective pixels of a display panel of the embodiments;

FIG. 8 shows a structural example for detecting defective pixels of a display panel of the embodiments;

FIG. 9 shows a structural example for detecting defective pixels of a display panel using a comparator;

FIG. 10 is a timing chart for the structure of FIG. 8;

FIG. 11 is a drawing showing another structure for a pixel circuit; and

FIG. 12 is a drawing showing an I-V curve for an organic EL element.

### DETAILED DESCRIPTION OF THE INVENTION

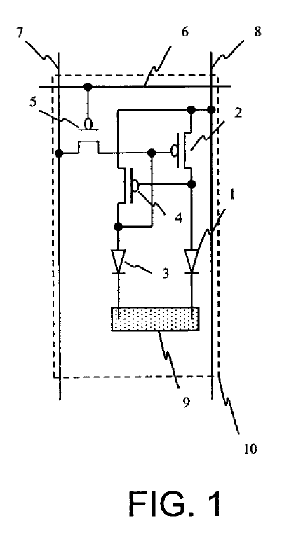

Embodiments of the present invention will be described in the following based on the drawings. FIG. 1 shows one example of a pixel 10 having a one-bit static memory included three transistors and two organic EL elements.

Cathodes of a first organic EL element 1 that contributes to light emission and a second organic EL element 3 that is shielded or the like and does not contribute to light emission are connected to a cathode electrode 9 that is common to all pixels and to which power supply voltage VSS is supplied. An anode of the first organic EL element 1 is connected to the drain terminal of a first drive transistor 2, while the anode of the second organic EL element 3 is connected to a drain of a second drive transistor 4. A source terminal of the first drive transistor 2 and a source terminal of the second drive transistor 4 are connected to a power supply line 8 common to all pixels and to which power supply voltage VDD is supplied. A gate terminal of the first drive transistor 2 is connected to a source terminal of a gate transistor 5 and to a connection point of the second organic EL element 3 and the second drive transistor 4, while a gate terminal of the second drive transistor 4 is connected to a connection point of the first organic EL element 1 and the first drive transistor 2. The gate terminal of the gate transistor 5 is connected to a gate line 6, while the drain terminal of the gate transistor 5 is connected to the data line 7.

If the gate line 6 is write selected (Low voltage supplied so that the on resistance of the gate transistor 5 becomes low compared to the on resistance of the second drive transistor 4) a high or low digital signal supplied to the data line 7 is fed to the gate terminal of the first drive transistor 2. If data is Low, the first drive transistor 2 is turned on, and current flows in the first organic EL element 1, emitting light. Since as a result of this the anode potential of the first organic EL element 1 rises to the power supply potential VDD, the second drive transistor 4 is turned off and the anode potential of the second organic EL element 3, that is the gate potential of the first drive transistor 2, falls to close to the cathode potential VSS. Even if the gate line 6 is unselected and the gate transistor 5 is off, the gate potential of the first drive transistor 2 is held at the cathode potential VSS, and so the first organic EL element 1 can continue to emit light.

If data is High, the first drive transistor is turned off, and so current no longer flows in the first organic EL element 1 and it is turned off. Because the anode potential of the first organic EL element 1 is lowered to the cathode potential VSS, the second drive transistor 4 is turned on. The anode potential of the second organic EL element 3 rises to the power supply potential VDD, and the gate potential of the first drive transistor 2 is held at the power supply potential, which indicates that the gate line 6 is unselected, and even if the gate transistor 5 is off the first organic EL element 1 can be kept off.

In this manner, the pixel 10 holds digital data that has been written once, and so it is not necessary to periodically repeat a write operation in order to maintain the same data.

Also, if the data line 7 is pre-charged to Low and the gate line 6 is read selected (a Low voltage higher than that causing the on resistance of the gate transistor 5 to be larger than the on resistance of the second drive transistor 4 is applied), digital data written to the pixel 10 can be read out to the data line 7. When the gate terminal of the first drive transistor 2 is being held High, the data line 7 is pre-charged to Low, and if the gate line 6 is read selected current flows from the power supply line 8 through the second drive transistor 4 and the gate transistor 5 to charge the data line 7 to power supply voltage VDD.

During this time, the on resistance of the gate transistor 5 is large compared to the on resistance of the second drive transistor 4, and so the gate potential of the first drive transistor 2 is maintained to the High side by resistance division Data is therefore not corrupted by read out. When the gate terminal of the first drive transistor 2 is being held Low, the data line 7 is pre-charged to Low to read select the gate line 6, but because the data line 7 is also Low current does not flow and there is no change to the Low potential to which the data line 7 has been pre-charged. In this way, after a fixed time has elapsed from read select, it is possible read out data being held in the static memory by taking in the data line 7 potential.

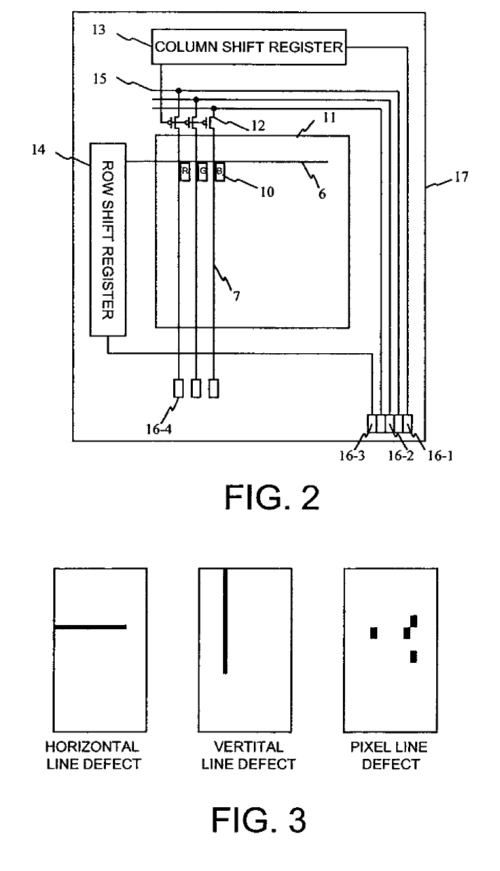

FIG. 2 shows a defect detection circuit for detection of defects introduced into an active matrix type organic EL display. Pixels 10 with the above-described readable and writable static memory are arranged in a matrix form to make a display array (display region) 11. Data lines 7 arranged in the column direction of this display region are connected to a data bus 15 in order from left to right, for example, by a column shift register 13 and bus switches 12. Also, gate lines 6 arranged in the row direction are sequentially selected from top to bottom, for example by a row shift register 14, and data supplied to the data bus 15 is written to the pixels 10.

In FIG. 2 RGB data buses are shown, and RGB data is input at one time and supplied the corresponding data lines 7. At this time, the row shift register 14 sequentially selects gate lines 6 one at a time, and so while an nth line is write selected bus switches 12 the same in number as the number of pixel for one line are sequentially turned on from left to right by the column shift register 13 to connect the data bus 15 to the data lines 7. As a result, RGB data for the n^{th} line supplied to the data bus 15 is written to each pixel 10. Conversely, if the line is read selected, data for one line that has been read once from a pixel 10 is held on the data line 7, and data read onto the data line 7 is read out from the data bus 15 by the bus switches 12 sequentially connecting the data lines 7 and the data bus 15.

Signals input from outside to the column shift register 13, row shift register 14 and data bus 15, or signals output to the outside, are transferred by way of the IO pads 16. Specifically, control signals generated from external signal generators etc. to the column shift register 13 and row shift register 14, and power supply voltages, are respectively input from the IO pads 16-1 and 16-3. Access to the data bus 15 for inputting RGB data from outside and output data read from the pixels 10 is performed via the IO pads 16-2.

When performing final defect detection after forming the organic EL elements on the TFT substrate, it is necessary to illuminate all pixels to detect whether or not there are defective pixels, but in the case of pixels with no static memory it is normally necessary to illuminate all pixels by writing image data at 60 Hz. If the resolution of the panel is high or the size is large, there is a need for low impedance outputs and high speed data transfer. For this reason, it is necessary to install a driver IC and perform lighting tests by connecting IO pads of the driver IC to the 10 pads 16-4. However, even supposing that defect inspection can be performed with a driver IC installed, in the event that panel defects exist to an unacceptable level, and they will not be corrected the installed driver IC can not be reused, increasing inspection costs.

On the other hand, with this embodiment a static memory is incorporated into each pixel 10. This indicates that if data is written all at once, that data is maintained and it is not necessary to periodically write data. If this function is used, then since there is no need for refresh at the 60 Hz normally required for performing display, it is possible to lower the data transfer speed from outside. Therefore, the use of high performance transistors such as low temperature polysilicon TFTs makes it possible to write data to all pixels through operation of the column shift register 13, row shift register 14 and bus switches 12 even if the display array 11 is large or high resolution, and perform appropriate display with no flicker. Specifically, since it is not necessary to operate the column shift register 13, row shift register 14 and bus switches 12 at high speed, their circuit structures can be simplified, and incorporation onto a TFT substrate is made easier.

For example, if writing for pixels is done with one pixel per RGB respectively, even with a low temperature polysilicon TFT having an operable period of 1 μs, it is possible to write data to all pixels in about two seconds even with the resolution of full high-vision (1920×1080). This is sufficiently fast for inspection. If it were necessary to refresh this data at 60 Hz, data transfer would need to be carried out, per single RGB pixel, at 60×1920×1080=124 MHz (8 ns), which is extremely difficult with low temperature polysilicon TFTs. Even if this is possible, the bus width would be increased, and a greater number of circuits would be used, making it more likely that shorts will arise in the bus wiring adopted to detect these as well as circuit defects, and pixel defect detection is complicated. Specifically, using pixels 10 adopting a static memory suppresses defects in peripheral circuits for pixel defect detection, and also does away with the need for provision of a driver IC, making it possible to minimize inspection cost.

The static memory of the pixel 10 is also capable of reading data. If this function is utilized, then after writing data to all pixels once it is possible to verify written data by reading data one pixel at a time. This aspect will be described in more detail in the following using FIG. 1.

If a defect occurs in the first organic EL element 1 and the cathode electrode 9 and the anode of the first organic element 1 are short circuited, the gate terminal of the second drive transistor 4 is always Low, and so read data will always be High. At the time of verification, Low (white data) is written, and High (black data) is read out, which indictes that verify errors are obvious. If verification is performed by writing white data to all pixels and reading white data from all pixels, and then verifying by writing black data to all pixels and reading out black data, it is possible to determine whether or not the black and white operation of all pixels is appropriate. Alternatively, it is also possible to carry out verification using a verification pattern such as a checkered pattern, vertical stripe pattern or horizontal stripe pattern. Defects that have been detected using this type of verification are not only those relating to the organic EL elements, but also include open circuit faults in the TFTs and between wiring, but regardless of the type of fault, if the location of all defective pixels is specified in this way it is possible to generate a defect map such as is shown in FIG. 3.

FIG. 3 shows one example of defect maps for horizontal line defect, vertical line defect and pixel defect. Using white as a normal pixel and black as a defective pixel, these maps are created corresponding to positions of pixels 10 in a display array 11 so as to make it easy to understand verify errors detected as described previously. From this defect map, the case of pixels in a continuous horizontal line can be considered an open circuit gate line 6, and the case of pixels in a continuous vertical line can be considered an open circuit data line 7, and if there are pixel defects it can be considered that an individual organic EL element or TFT is defective, and classification of defects by determining data read out by verification becomes possible as well as looking at the display.

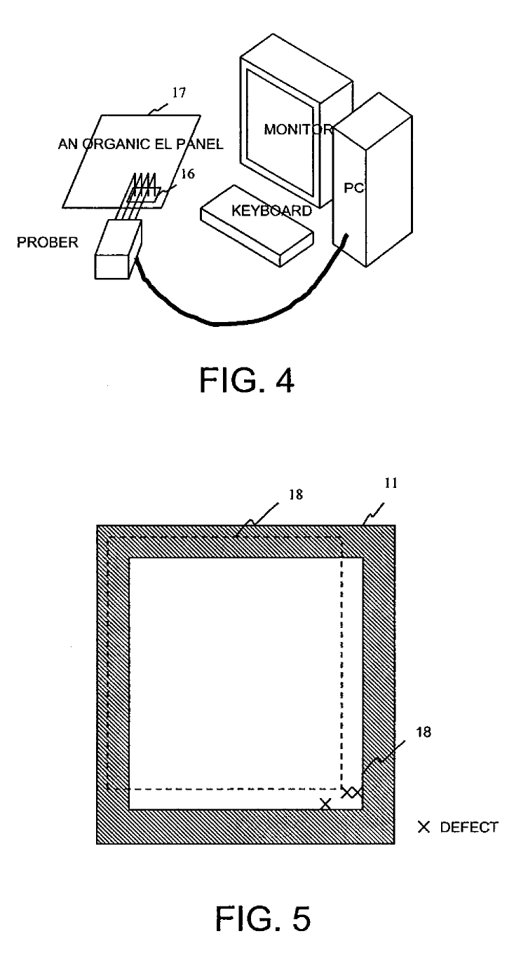

At the time of verification, the organic EL display is lit up, so it is possible to tell just by looking at the display, but if the defect analysis system as shown in FIG. 4 is constructed it is possible to perform defect detection for a large scale panel automatically and more rapidly.

The defect analysis system of FIG. 4 includes a prober for assigning control signals, data and power supply through probe terminals to IO pads 16 of an organic EL panel 17 having a verify function, and a single personal computer (PC). Control signals, data and power supply are supplied through probe terminals to the IO pads 16 of the organic EL panel 17 to carry out the previously described verification, and detect pixel defects of all pixels. Verify error data is sent from the proper to the PC, a defect map as shown in FIG. 3 is created by PC software, and the number of defective pixels is displayed on a monitor together with defect characteristics. In the event that defects are within admissible conditions, the display panel 17 is transferred to the next manufacturing state, but if there is deviation from the admissible conditions confirmation is carried out by an operator checking defect content against actual display and operation transfers to details specification and solution of the problem. All of this panel defect information can be made into a database, making it possible to keep track of when what defects arose in what panel process and at what time, and easily understand yield improvement conditions.

The automated defect detection results are to classify panels into those that have room for improvement and those that do not, and those with room for improvement are subjected to the improvement strategy shown in FIG. 5. FIG. 5 shows an example of a redundant configuration for a display array 11. Normally, the number of pixels of an effective display region 18 is a number defined by specifications, for example, with full high vision the effective display region is made up of 1920×1080 pixels, but with the example shown in FIG. 5 there are, for example, a further 100 pixels at the left and right and 50 pixels at the top and bottom to give a structure with 2120×1180 pixels. The shaded area of the display array 11 is a standard redundancy region, and in the case where it has been ascertained through the previously described verification that there are prominent defective pixels at a lower right end of the standard effective pixel region shown in white (position denoted by x), it is possible to prevent the organic EL panel 17 becoming defective by moving the effective display region 18 to the dotted line region. Since it is possible to search for regions with no defects using automatic image defect detection, it is possible to find an appropriate region with permissible defects, and reset the effective display region.

In the case where it has been determined that there are also defective pixels that cannot be permitted in the destination effective display region 18, it is undesirable to reset the effective display region as described previously. In this case, it is better to be able to dynamically set the effective display region 18 so that it is shifted slightly after a specified time has elapsed without the effective display region 18 being fixed. In the event that an effective display region 18 is set in a standard effective display region of the white section in FIG. 5 in such a time frame, the pixel defects can be seen to the bottom right of the screen, but at the next point in time the effective display region is moved to the dotted line region and so despite the fact that defects in the dotted line region affect display, there is no effect due to the lower right defects. Since defects cannot be seen at a fixed position, it is possible to anticipate the effect that they will not stand out. Further, since the effective display region is moved, it is possible to expect the effect of avoiding screen burn in.

Making it possible to reset a more flexible effective display region has the effect of avoiding defect display and avoiding screen burn in, and it is desirable to secure a larger redundant display region. However, since the redundant display region is viewed as a frame at the time of use, and if it is large visual quality is not very good, it would be better to keep the redundant display region to about 10% or less of a general panel size.

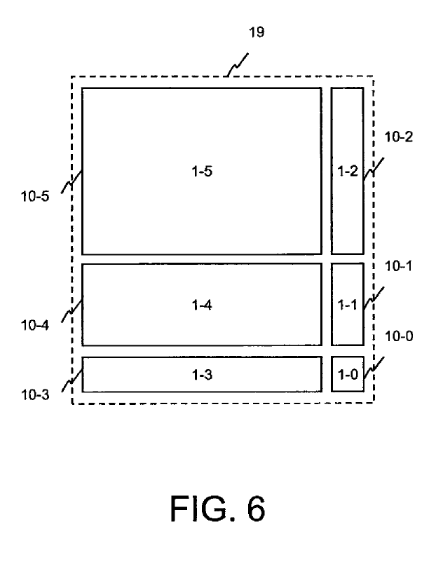

In the case where the location of defects is mainly in the center of the display array 11, it will be difficult to avoid defects using only the method shown in FIG. 5, but it is possible to make the defects less noticeable by adopting the pixel structure shown in FIG. 6.

FIG. 6 shows an example of a plurality of sub pixels, in this case one unit pixel 19 adopting 6 bits (pixels for either of RGB), being formed in a pixel 10. The ratio of emission intensity of each of the sub pixels 10-0 to 10-5 is respectively set at 1:2:4:8:16:32, and in FIG. 6 this is realized by varying the light emission surface area of the first organic EL element 1. However, even if the light emission surface area is varied, it is not strictly necessary to increase by a power of two each time. Specifically, if an application such as a television is assumed, average brightness is about 20%-30% of peak brightness, and pixels are lit up more frequently, which indicates that considering degradation it is advisable to make the light emission surface area of pixels having the above-described emission intensity ratio of 16/63 larger, and considering temperature, to control degradation by making light emission surface area for emission intensity ratio 32/63, that is more prone to be affected, to be even larger. In this case, since the light emission strength is large compared to an assumed ratio, desired light emission strength is realized by controlling light emission period.

Here, it is possible to realize ratios of emission intensity for the sub-pixels 10-0 to 10-5 without changing the light emission surface area. In FIG. 11, a fixed current drive transistor 24 is inserted in series between the first drive transistor 2 and the first organic EL element 1. Specifically, the fixed current drive transistor 24 has its gate terminal connected to a current control line 25, and by controlling a potential supplied to this current control line 25 it is possible to vary the emission intensity of the first organic EL element 1. Thus, by varying the potentials of current control lines 25 respectively connected at each of the sub-pixels, it is possible to vary the emission intensity of each sub-pixel. With the pixel 10 of FIG. 11 when the current control line 25 is made Low the fixed current drive transistor 24 is normally on and operates, and if memory data read and write can be carried out similar automatic defect detection can be carried out.

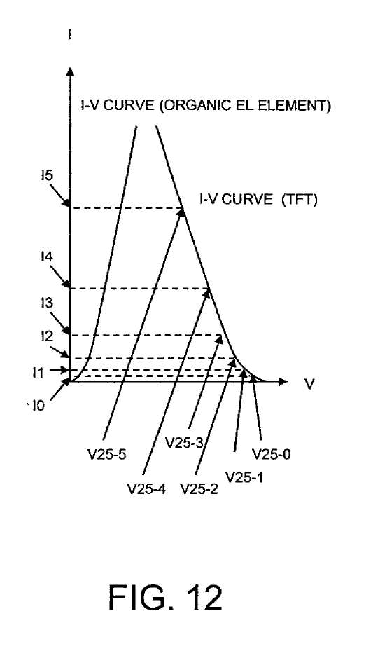

In the case of 6 bits, six current control lines 25 are connected to gate terminals of fixed current drive transistors 24 provided in respective sub-pixels, and it is possible to supply six different potentials (V25-0 to V25-5) are supplied to give current ratios (10:11:12:13:14:15=1:2:4:8:16:32) such that emission intensity ratios are as described above, as shown in FIG. 12. If the pixel of FIG. 11 is used, then since it is possible to set the emission intensity with the current value of the first drive transistor 2, it is not necessary to vary emission surface area and current setting can be carried out arbitrarily which shows control is simple.

Incidentally, current will be concentrated at the first organic EL element 1 of sub-pixel 10-5, which is the MSB, and that sub-pixel will deteriorate quickly. However, it is possible to resolve this type of problem by exchanging the MSB sub-frame pixels in frame units or a specified period with another sub-pixel, and to switch the potential V25-5 of the current control line 25-5 with the potential V25-i of any of the remaining current control lines 25-i. In particular, in the case of surface area gradation, construction is difficult because emission surface area of the LSB sub-pixel is extremely small, being 1/32 compared to that of the MSB. It is therefore preferable to have the pixel of FIG. 11 only for the LSB sub-pixel, and set the emission intensity low. As a result, the number of current control lines required is also reduced.

If a plurality of sub-pixels are adopted inside a unit pixel as in FIG. 6, then even if defects arise in the organic EL element of one of these sub-pixels the defect does not appear in the one unit pixel as long as operation of the other sub-pixels is normal. In the case of a unit pixel being made up of only one pixel, then since a single defect constitutes a defect of the unit pixel the risk of defective pixels is high, but if a plurality of sub-pixels are adopted it can be expected that the risk will be dispersed. In the case of surface area gradation, in particular, a defect of sub-pixel 10-5, which is the MSB, has a significant effect on the emission intensity of the unit pixel. For this reason, handling of whether or not this MSB sub-pixel has a defect is given precedence. After inspection of all pixels for defects using the previously described automatic defect detection, if a defect is detected and that defect is toward the center, it is evaluated whether or not the defect is for the MSB sub-pixel. If it is not an MSB sub-pixel defect, the permissible amount of defects for the unit pixel is set low, and defect evaluation is kept low. This is because if the dynamic effective display region setting as in FIG. 5 is adopted, then the location of the defect is relatively moved, which indicates that if at least the MSN sub-pixel is operating normally it can be determined that a defect is unlikely to be prominent. However, if the defect is in the MSB sub-pixel, defect determination is performed according to the defect state of any of the other sub-pixels. If other sub-pixels are operating normally and it is possible, using the dynamic effective display region setting of FIG. 5 to determine that the defect will not be prominent, then a good product is determined, and in the case where there are a lot of defects of surrounding MSB sub-pixels, it is likely that the product will be determined to be defective.

Using the sub-pixel shown in FIG. 11, with six sub-pixels having completely the same emission surface area, in the case of controlling gradation by controlling supplied current it is possible to switch the MSB sub-pixel, and it is not fixed, which shows that image defects are unlikely to be prominent. In this manner, if a unit pixel is formed using a plurality of sub-pixels, a defect does not always result directly in a defective unit pixel and so it is possible to improve yield.

Incidentally, it is better for the number of sub-pixels that that can be adopted to be high, but three bits or four bits is also effective. However, if a lot of sub-pixels are adopted in the unit pixel as in FIG. 6, the number of pixels is increased which required verification time, and so it is preferable to perform defect determination by preferentially performing automatic defect detection from the MSB sub-pixels, to shorten the verify time.

Description has been given above for defect detection carried out before shipping, but in the following a description will be given of defect detection after shipping.

Since organic EL are semiconductors using organic material, it generally has low reliability compared to semiconductors formed from inorganic material such as low temperature polysilicon TFTs. Specifically, it is normally necessary to guarantee the pre-shipping reliability level even after shipping has taken place, but there is concern about lowered reliability dependent upon usage conditions. For example, in the case of organic EL, the elements become high resistance with degradation, making it difficult for current to flow, and there is a possibility that it will become difficult for static memory incorporated into the pixels 10 to operate normally. Therefore, it is preferable to carry out defect detection after shipping also using the read function of the pixels 10, and in this way it is possible to guarantee that the pixel will operate normally.

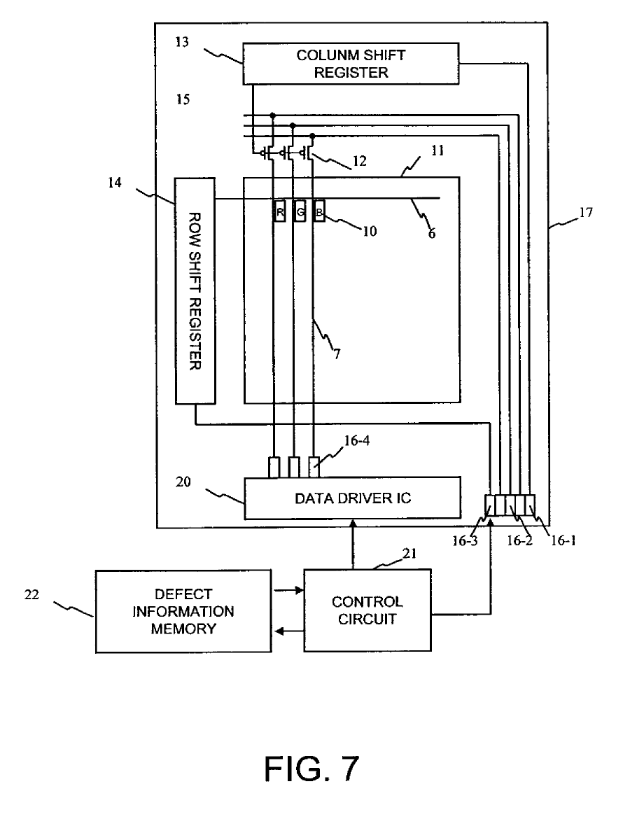

As shown in FIG. 7, at the time of shipping the product is shipped with the organic EL panel 17 having IO pads of a data driver 20 connected to IO pads 16-4. However, since there is a possibility of connecting to the data bus 15 to the data lines 7 via other bus switches 12, at the point in time where the data driver IC 20 is connected, the column shift register 13 is controlled to transmit an off signal to all of the bus switches 12. For example, it is possible in the column shift register 13 to fix the control signal supplied from the IO pad 16-1 by pulling up or pulling down with a resistance element.

Defect detection before shipping also takes place after connecting the data driver 20, but even if a defect is detected here it is a defect due to connection of the data driver IC 20 and so improvement is simple. There are also situations where a gate driver IC is connected instead of the row shift register 14, but in FIG. 7 the row shift register 14 is used as a gate driver.

An organic EL panel 17 that has been shipped with the data driver IC 20 connected has data driver control signals and image data supplied from a control circuit 21 to the data driver IC 20, and gate driver control signals are also supplied to a gate driver (row shift register 14) to normally operate as a display. Defect information detected before shipping is information corresponding to individual organic EL panels 17 shipped with this information prestored in a defect information memory 22 formed from non-volatile memory such as flash memory. Here, positions of defective pixels are listed in the defect information, and is, for example, a small amount of data for a few tens of pixels.

In this embodiment, in part of a non-usage time of the display, automatic defect detection using the above-described verification is carried out by the data driver IC 20. Differing from automatic defect detection before shipping, this is carried out at high speed because reading and writing of data to and from the pixels 10 by the data driver IC 20 is carried out in line units. Also, the control circuit 21 checks that defects have not increased on the basis of defect information of the defect information memory 22. If the defect locations increase, the defect information memory 22 is updated, and as shown in FIG. 5 the effective display region is reset to an appropriate position. If the effective display region is updated dynamically, desired regions as set regions are limited on the basis of the defect information. By updating the defect information in this manner, it is possible to keep the effect on display to a minimum, even if the defective pixels increase. The control circuit 21 and the defect information memory 22 can be built in to the data driver IC 20.

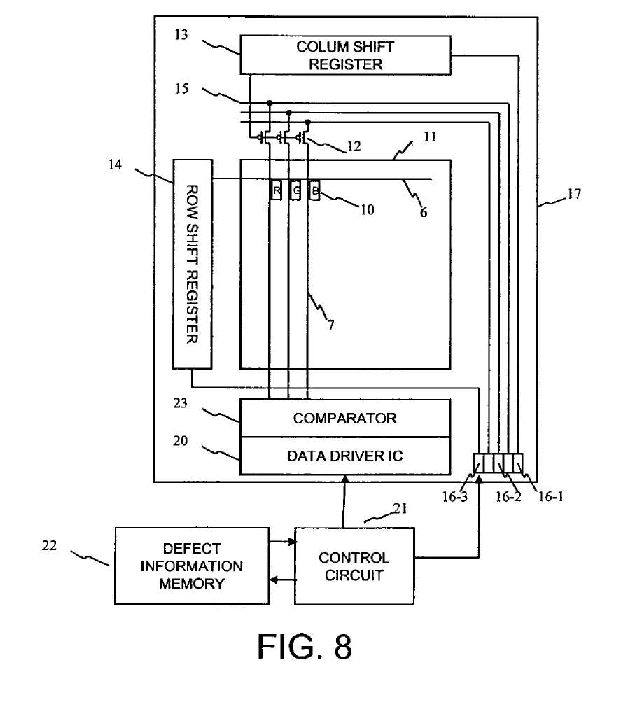

Further, by using the structure of FIG. 8, it is possible to avoid burn in that arises after shipping, which is of the greatest concern in organic EL displays. Burn in can be regarded as some late developing defects of the previously mentioned pixels, and can be reduced by incorporating the comparator 23 as shown in FIG. 8.

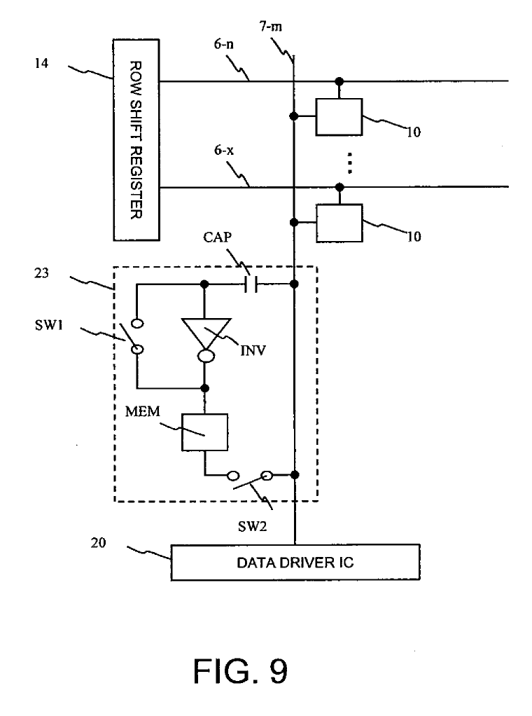

FIG. 9 shows an example of detecting degradation of a pixel of an n^{th} row m^{th} column using a comparator 23 and an x^{th} line (reference line 6-x) constituting a reference provided outside the display section. The same pixels 10 as the display section are provided on the reference line 6-x. Input output terminals of the data driver IC 20 are connected to each data line 7, and one comparator 23 is connected. The comparator 23 includes a first switch SW1, an inverter INV, a retention capacitor CAP, a 1-bit memory MEM and a second switch SW2. The data line 7 is connected to the input of the inverter INV via the retention capacitor CAP. The input and output of the inverter INV are connected using the first switch SW1, with the output being connected to the 1-bit memory MEM. The second switch SW2 controls whether or not output of the 1-bit memory MEM is output to the data line 7.

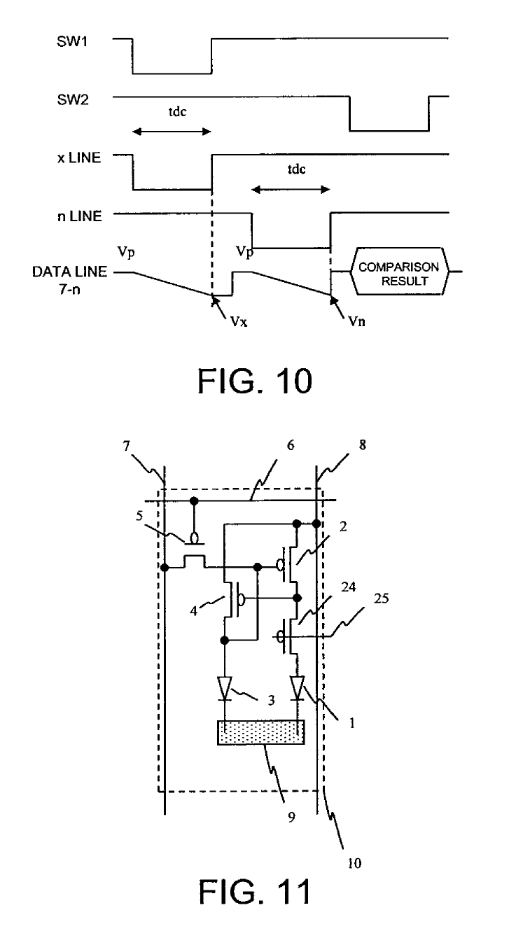

Operation of the comparator 23 will be described using FIG. 9 and FIG. 10. An example of the data line 7-m of the m^{th} column is shown in FIG. 9, but the other data lines 7 also operate in the same way, and are controlled in line units. The pixel circuit is the circuit shown in FIG. 1.

First of all, the data line 7 is pre-charged with a potential Vp that will turn the first drive transistor 2 on. At the same time as the first switch SW1 is turned on, if the x^{th} line is selected then the first drive transistor 2 of the x^{th} line is turned on and the second drive transistor 4 is turned off, and as a result charge that has been pre-charged to the data line 7 is discharged from the second organic EL element 3 during the period tdc that the x^{th} line is selected. The data line 7 is gradually lowered from Vp as discharge progresses, then at the same time as the first switch SW1 is turned off the x^{th} line is deselected to stop discharge of the data line 7. The potential Vx of this data line 7 is sampled to the retention capacitor CAP when the first switch SW1 is opened. Next, after the data line 7 has been pre-charged once more to Vp, if the n^{th} line is selected and discharged in the same period tdc to deselect the n^{th} line the potential of the data line 7 becomes Vn. If the degree of deterioration is different for the second organic EL element 3 of the x^{th} line and the second organic EL element 3 of the n^{th} line, discharge characteristics will also differ due to being made high resistance, and the respective potentials Vx and Vn after discharge will be different. This difference is amplified by the inverter INC, and the result is stored in the 1-bit memory MEM.

The inverter INV operates as a comparator, as described in the following. While the first switch SW1 is closed, if the data line 7 is at potential Vx and the first switch is off, the potential Vx acts as a threshold value for the inverter INV. This is because it is equivalent to setting so that if the first switch SW1 is on, the input of the inverter INV becomes a point between High and Low (a threshold value or reference value), and so that the input of the inverter INV becomes the threshold value when the data line 7 becomes Vx on the retention capacitor CAP. Accordingly, while the first switch SW1 is off, if the potential of the data line 7 is made Vx or less the inverter INV inverts. If this operation is utilized, it is possible to perform a comparison between Vx and Vn. Specifically, a reference voltage for the comparator 23 is first set to the potential Vx of the xth line, then the potential Vn is compared with the reference potential Vx and the result stored in the 1-bit memory MEM.

Data stored in the 1-bit memory MEM is reflected onto the data line 7 by switching the second switch SW2 on, and results are read from the input terminal of the data driver IC 20. This series of operations is carried out for all data lines 7, which indicates processing is performed in line units and it is possible to read out differences in degradation of the x^{th} line and the n^{th} line at high speed.

Similarly for the case of the n+1^{th} line also, first the reference voltage for the x^{th} line is set in the comparator 23, and the potential Vn+1 of the n+1^{th} line is compared. Comparison data is stored in the 1-bit memory MEM, and read into the data drive IC 20. If this is repeated for all lines, it is possible to read out difference in degradation of the second organic EL element 3 when the x^{th} line of all pixels is made a reference, and it is possible to confirm difference in degradation for each pixel.

With FIG. 9 the voltage values Vx and Vn of the data line 7 have been compared using the comparator 23, but is also possible measure to current values Ix, In when Vp is applied, using a current measurement circuit or the like (not shown), and to compare these current values.

The second organic EL element 3 operates in a complementary fashion so as to not emit light while the first organic element 1 is emitting light, and conversely to emit light when the first organic EL element 1 is not emitting light, and so a reverse characteristic for the degradation of the first organic EL element 1 is reflected at the second organic EL element 3. Specifically, the fact that the second organic EL element 3 is degraded shows that the first organic EL element 1 is not degraded, and as long as the second organic EL element 3 is not degraded, degradation of the first organic EL element 1 advances.

In the case where the difference in degradation has been confirmed, degradation equalization processing, that will be described next, is carried out in a display non-use period. A pixel having less degradation than the reference line is illuminated for part of the non-use period, to forcibly cause degradation. At this time, since the degradation equalization processing will not be noticeable if the pixel is not lit up very brightly, it is preferable to perform gentle degradation by lowering the power supply voltage VDD further, etc. After a fixed time has elapsed, degradation comparison is again carried out for every pixel with the reference line, and subject to confirmation that the number of pixels that are brighter than the reference line has decreased, it is determined whether or not to carry out degradation equalization again. In the event that there are still a lot of pixels with slight degradation, the equalization processing is performed again, followed by degradation comparison. Once the pixels having slight degradation satisfy a specified condition, the equalization processing is finished, and a state where burn in has been equalized is maintained.

Here, the reference line preferably causes operation so that during a usage period of the display all pixels of one line are lit at the same brightness to give the same degradation, and it is also possible to shorten the discharge period tdc, to perform control so as to cause apparent degradation and carry out degradation comparison. It is also possible to form the comparator 23 on the same substrate as the pixels, and it is also possible to adopt the comparator 23 inside the data driver IC 20.

In this way, it is possible to further improve reliability of display after shipping by verifying pixels periodically after shipping, and monitoring degradation states.

The invention has been described in detail with particular reference to certain preferred embodiments thereof, but it will be understood that variations and modifications can be effected within the spirit and scope of the invention.

### PARTS LIST

1 organic EL element
2 first drive transistor
3 organic EL element
4 second drive transistor
5 gate transistor
6 gate line
7 data line
8 power supply line
10 pixel
11 display array
12 bus switches
13 shift register
14 row shift register
15 data bus
16 IO pads
17 organic EL panel
18 display region
19 unit pixel
20 data driver IC
21 control circuit
22 defect information memory
23 comparator
24 current drive transistor
25 current control line

1. A method of detecting a defect in a display panel, comprising:
(a) providing a display panel comprising a plurality of pixels arranged in a matrix form, wherein each pixel comprises a static memory and emits light according to data stored in the static memory;
(b) writing data to the static memory of each pixel;
(c) reading the data stored in the static memory of each pixel; and
(d) comparing the data written and read for each pixel to produce a respective comparison result indicating presence of a defect.

2. A display panel comprising:
(a) a display array having a plurality of pixels arranged in rows and columns, wherein each pixel comprises a static memory and emits light according to data stored in the static memory;
(b) a plurality of data lines connected to the pixels in each respective pixel column;
(c) a data driver connected to the plurality of the data lines for supplying data to the pixels and for reading values from the static memories in the pixels;
(d) a plurality of gate lines connected to the pixels in each respective pixel row;
(e) a row shift register connected to the plurality of gate lines for activating each pixel row to either read or write data; and
(f) a control circuit for selectively controlling the data driver and row shift register for writing data to or reading data from each pixel.

3. The display panel of claim 2, further comprising:
(g) a comparator connected to each data line and to the control circuit for acquiring and storing first data on a data line, then comparing stored first data with second data on the data line and providing the resulting comparison result to the control circuit.

4. The display panel of claim 2, wherein the control circuit causes image data to be displayed in an effective display region having fewer pixels than the display array.

5. The display panel of claim 4, wherein the location of the effective display region is not fixed.

6. The display panel of claim 5, wherein the location of the effective display region within the display array is changed to a plurality of different position after a predetermined number of frames of image data.

7. The display panel of claim 5,
wherein the control circuit compares the data written and read to each pixel to create defect positions;
further comprising a defect information memory for storing information about defect positions,
and wherein the position of the effective display region is set based on information in the defect information memory.

8. A unit pixel, comprising a plurality of sub-pixels which can be exchanged with each other.

9. The unit pixel of claim 8, wherein the sub-pixels have respectively different display brightness.

10. The unit pixel of claim 9, wherein the sub-pixels have respectively different surface areas.

11. The unit pixel of claim 9, wherein the sub-pixels have the same surface area, and wherein each sub-pixel has a different magnitude of drive current.
